(19) United States
(12) Patent Application Publication
(10) Pub. No.: US 2008/0137581 A1
(43) Pub. Date: Jun. 12, 2008

(54) DATA FORWARDING TECHNIQUES FOR WIRELESS RELAY NETWORKS

(75) Inventors: Klaus Doppler, Espoo (FI); Pirjo Pasanen, Vantaa (FI)

Correspondence Address: BRAKE HUGHES BELLERMANN LLP, c/o INTELLEVATE, P.O. BOX 52050, MINNEAPOLIS, MN, 55402, US

(73) Assignee: NOKIA CORPORATION, Espoo (FI)

(21) Appl. No.: 11/609,891

(22) Filed: Dec. 12, 2006

(51) Int. Cl. H04B 7/14

(52) U.S. Cl. 370/315

(57) ABSTRACT

Various example embodiments are disclosed relating to wireless networks, such as relay networks or multi-hop networks. According to an example embodiment, a wireless network may be provided that may include one or more relay nodes operating in a decode-and-forward (DF) mode, and one or more relay nodes operating in an amplify-and-forward (AF) mode. According to an example embodiment, a block of data may be received at a relay node via a first carrier frequency from a first wireless node. For example, the first wireless node may be operating in a DF mode. The block of data may be forwarded from the relay node to a second wireless node via a second carrier frequency using an amplify-and-forward (AF) mode.

### BACKGROUND

The rapid diffusion of Wireless Local Area Network (WLAN) access and the increasing demand for WLAN coverage is driving the installation of a very large number of Access Points (AP). The most common WLAN technology is described in the Institute of Electrical and Electronics Engineers IEEE 802.11 family of industry specifications, such as specifications for IEEE 802.11b, IEEE 802.11g and IEEE 802.11a. Other wireless technologies are being developed, such as IEEE 802.16 or WiMAX technology, etc.

As an example, a wireless relay network may include a multi-hop system in which end nodes such as mobile stations (MSs) or mobile nodes (MNs) may be coupled to an Access Gateway (AG) (also known as Access Point or Base Station) via one or more relay nodes (RNs) (also known as relay stations (RSs)). Thus, traffic between MNs and the AG may, in some cases, pass and/or be processed by the RNs. However, such a relay network may typically include multiple hops between an AG and a MN, which may in some cases introduce significant latency or delay for communications.

Techniques are desirable that may decrease latency or delay for wireless networks, such as for multi-hop or relay networks.

### SUMMARY

Various example embodiments are disclosed relating to relay networks or multi-hop networks, and also relating to data forwarding techniques for wireless networks.

According to an example embodiment, a wireless network may be provided that may include one or more relay nodes operating in a decode-and-forward (DF) mode, and one or more relay nodes operating in an amplify-and-forward (AF) mode.

According to an example embodiment, a block of data may be received at a relay node via a first carrier frequency from a first wireless node. The block of data may be forwarded from the relay node to a second wireless node via a second carrier frequency using an amplify-and-forward (AF) mode.

In an example embodiment, the receiving may include receiving a block of data at a first radio interface of a relay node via a first carrier frequency, and the forwarding may include forwarding the block of data from a second radio interface of the relay node via a second carrier frequency using an amplify-and-forward (AF) mode.

According to another example embodiment, an apparatus may be provided. The apparatus may include, for example, a controller, a memory coupled to the controller, and a wireless transceiver coupled to the controller. The apparatus may be configured to select a forwarding mode of operation from a plurality of forwarding modes, the plurality of forwarding modes including an amplify-and-forward mode and a decode-and-forward mode. The apparatus may also be configured to receive a block of data from a first wireless node, and forward the block of data to a second wireless node using the selected mode. In another example embodiment, the apparatus may include a first wireless transceiver (or first radio interface)to receive a block of data via a first carrier frequency, and a second wireless transceiver (or a second radio interface) to forward the block of data via a second carrier frequency.

According to an example embodiment, a method may be provided, which may include the following. A relay node may be initially operating in a decode-and-forward (DF) mode. A data frame may be identified to be forwarded via an amplify-and-forward (AF) mode. The relay node may switch from a DF mode to an AF mode. The data frame may be received at the relay node via a first carrier frequency from a first wireless node. The received data frame may be forwarded from the relay node to a second wireless node (e.g., another relay node or a mobile node) via a second carrier frequency using the AF mode. The relay node may, for example, switch back to DF mode after forwarding one or more data frames, in an example embodiment.

According to another example embodiment, a wireless network may be provided that may include a plurality of wireless nodes. The wireless network may include a first relay node coupled, either directly or indirectly, to an access gateway, the first relay node operating in a DF mode. And, a second relay node coupled, either directly or indirectly, to the first relay node and to one or more mobile nodes being serviced by the second relay node, the second relay node operating, at least for a forwarding of some data blocks, in an AF mode.

The details of one or more implementations are set forth in the accompanying drawings and the description below. Other features will be apparent from the description and drawings.

### BRIEF DESCRIPTION OF THE DRAWINGS

FIG. 1 is a block diagram illustrating a wireless network according to an example embodiment.

FIG. 2 is a block diagram illustrating a wireless network according to an example embodiment.

FIG. 3 is a block diagram illustrating a wireless relay network according to an example embodiment.

FIG. 4 is a diagram illustrating a relay network according to another example embodiment.

FIG. 5 is a diagram illustrating a tree structure for a wireless network according to an example embodiment.

FIG. 6 is a diagram illustrating a 4-phase operation for transmission for a wireless network according to an example embodiment.

FIG. 7 is a diagram illustrating a wireless network that may include both amplify-and-forward (AF) relay nodes and decode-and-forward (DF) relay nodes.

FIG. 8 is a diagram illustrating forwarding of data by a node having two radio interfaces that have different bandwidths according to an example embodiment.

FIG. 9 is a flow chart illustrating operation of a wireless node according to an example embodiment.

FIG. 10 is a flow chart illustrating operation of a wireless node according to another example embodiment.

FIG. 11 is a block diagram illustrating an apparatus that may be provided in a wireless node according to an example embodiment.

### DETAILED DESCRIPTION

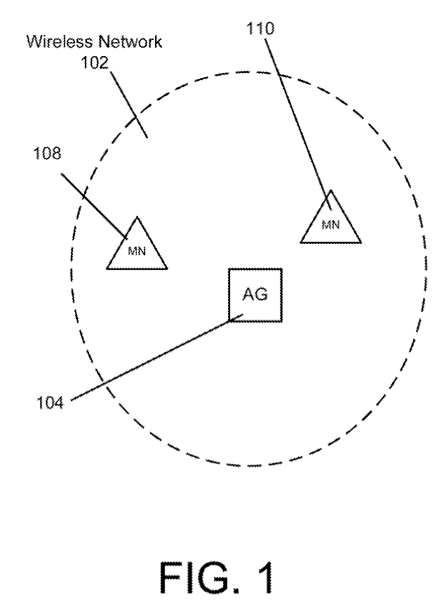

Referring to the Figures in which like numerals indicate like elements, FIG. 1 is a block diagram illustrating a wireless network 102 according to an example embodiment. Wireless network 102 may include a number of wireless nodes or stations, such as an access gateway (AG) 104 (or base station or access point) and one or more mobile stations or mobile nodes (MNs), such as MNs 108 and 1 10. While only one AG and two mobile nodes are shown in wireless network 102, any number of AGs and mobile nodes may be provided. Each node in network 102 (e.g., MNs 108, 110) may be in wireless communication with the AG 104, and may even be in direct communication with each other. Although not shown, AG 104 may be coupled to a fixed network, such as a Local Area Network (LAN), Wide Area Network (WAN), the Internet, etc., and may also be coupled to other wireless networks.

Although not shown in FIG. 1, in an example embodiment, one or more relay nodes or relay stations may also be provided in wireless network 102, e.g., to improve wireless coverage or data throughput. A wireless relay network may be an example of a multi-hop system in which end nodes, for example, mobile nodes (MNs) or mobile stations may be coupled to an access gateway (AG) or base station via one or more relay nodes (RNs) or relay stations.

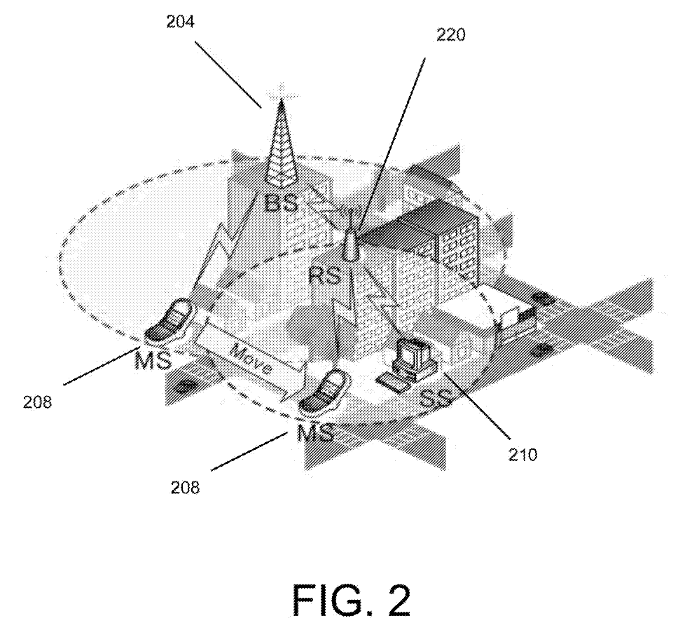

FIG. 2 is a block diagram illustrating a wireless network according to an example embodiment. According to an example embodiment, a mobile station (or mobile node) MS 208 may initially communicate directly with a base station BS (or AG) 204, for example, and a subscriber station (or other MN) 210 may communicate with the base station BS 204 via a relay station RS (or relay node) 220. In an example embodiment, the mobile station 208 may travel or move with respect to base station BS 204. For example, the mobile station MS 208 may move out of range of the base station BS 204, and may thus begin communicating with the base station 204 via the relay station 220 as shown in FIG. 2.

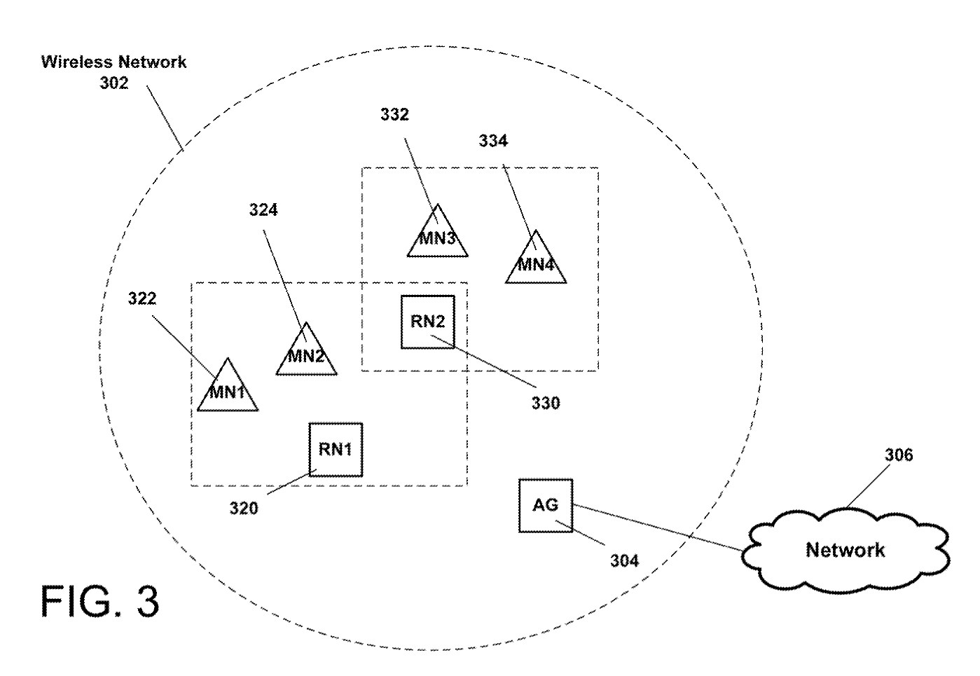

FIG. 3 is a block diagram illustrating a wireless network 302 according to an example embodiment. Wireless network 302 may include a number of wireless nodes or stations, such as an access gateway (AG) 304, relay nodes RN1 320 and RN2 330, a group of mobile nodes, such as MN1 322 and MN2 324 communicating with relay node RN1 320, and MN3 332 and MN4 334 communicating with relay node RN2 330. In an example embodiment, relay node RN2 330 may also communicate with relay node RN1 320. While only one AG, two RNs, and four MNs are shown in wireless network 302, any number may be provided. AG 304 may be coupled to a fixed network 306, such as a Wide Area Network (WAN), the Internet, etc., and may also be coupled to other wireless networks. The group of nodes MN1 322, MN2 324, and RN2 330 may communicate with the AG 304 via the relay node RN1 320, for example. The group of nodes MN3 332, MN4 334, may communicate with AG 304 via the relay node RN2 330, which may, for example, communicate with the AG 304 via the relay node RN1 320, for example. Wireless network 302 may be an example of a relay network or multi-hop network, and other configurations may be used.

In an example embodiment, the mobile nodes 322, 324, 332, 334 in FIG. 3 may include, for example, mobile telephones, cell phones, WLAN or WiMAX phones, wireless personal digital assistants (PDAs), or other types of wireless devices, or mobile stations/nodes. The AG may refer to an access gateway, base station, access point or similar device, and may be coupled to a wired network such as the Internet. The relay nodes (e.g., RN1, RN2) may include, for example, wireless nodes coupled between an AG and one or more mobile nodes. In some cases, there may be, for example, several RNs coupled in series between a MN and an AG, for example.

The various example embodiments described herein may be applicable to a wide variety of example networks and technologies, such as WLAN networks (e.g., IEEE 802.11 type networks), IEEE 802.16 WiMAX networks, relay networks, 802.16 Mobile Multi-hop Relay (MMR) networks, as referenced in IEEE 802.16 WG, WiMedia networks, Ultra Wide Band networks, cellular networks, radio networks, or other wireless networks. In another example embodiment, the various examples and embodiments may be applied, for example, to a mesh wireless network, where a plurality of mesh points may be coupled together via wired or wireless links. The various example embodiments described herein may be applied to wireless networks, both in an infrastructure mode where an AP or base station (or AG) may communicate with a station (e.g., communication occurs through APs), as well as an ad-hoc mode in which wireless stations may communicate directly via a peer-to-peer network, for example.

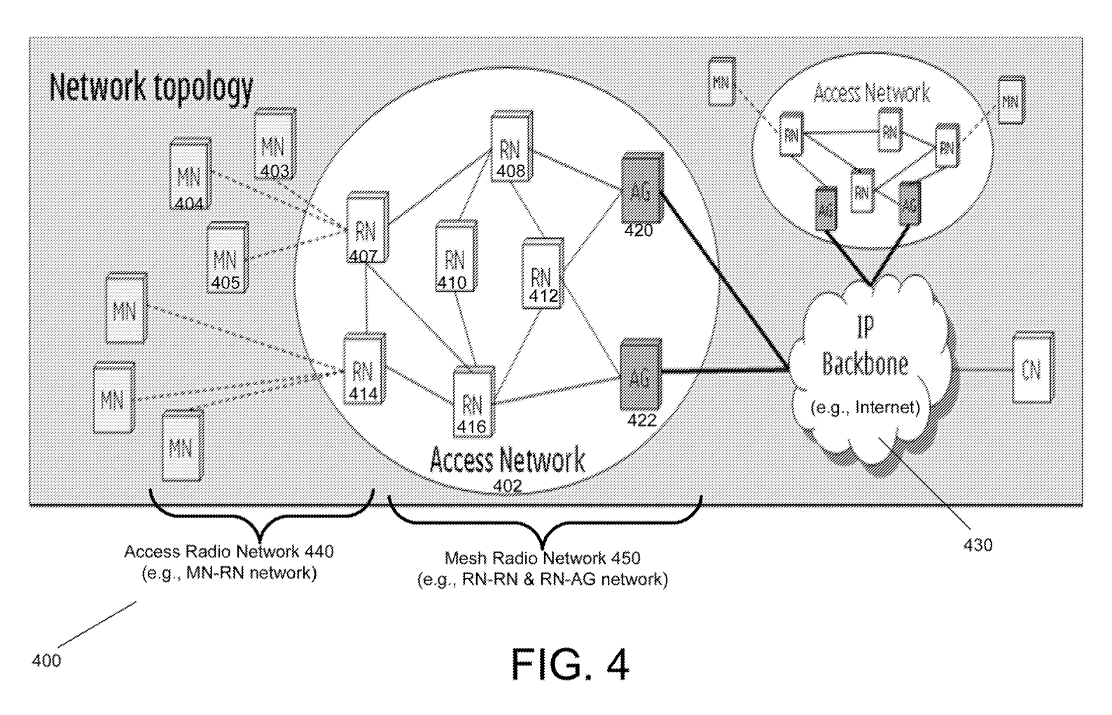

FIG. 4 is a diagram illustrating a relay network according to an example embodiment. As shown in the example of FIG. 4, one or more mobile nodes (MNs) are coupled to an IP (e.g., Internet Protocol) backbone (such as the Internet) via an access network 410. Access network 410 may include, for example, one or more relay nodes (RNs) and one or more access gateways (AGs). For example, mobile nodes (MNs) 403, 404 and 405 are directly coupled (e.g., wirelessly) to RN 407. One or more, or even a mesh of relay nodes, such as RNs 408, 410, 412, 414, 416, etc., may be provided to allow MNs 403-405 to communicate with AGs 420 or 422, for example.

According to an example embodiment, the network topology 400 illustrated in FIG. 4 may be considered to include an access radio network 440 and a mesh radio network 450. The access radio network 440 may include the MN-RN and AG-MN wireless interface or wireless media between mobile nodes (MN) 403, 404, 405, etc. and one or more relay nodes (RNs). A mesh radio network 450 may include the RN-RN and RN-AG wireless interface or wireless media, such as the wireless media for RNs to communicate with other RNs, and RNs to communicate with AGs.

According to an example embodiment, the wireless media (which may include one or more channels) of access radio network 440 may, for example, be separate or orthogonal from the wireless media for mesh radio network 450. Orthogonality between the two networks may be accomplished by using different channels (e.g., different channels or frequencies, different time slots, and/or different frequency hopping sequences, etc), for instance. For example, if OFDM (Orthogonal Frequency Division Multiplexing) is used, different sets of frequencies or subcarriers may be used for access radio network 440 and mesh radio network 450. Or, for example, if OFDMA (Orthogonal Frequency Division Multiple Access) is used, then different frequencies (or subcarriers) and/or time slots may be used between access radio network 440 and mesh radio network 450.

Orthogonality or independence between access radio network 440 and mesh radio network 450 may be accomplished, for example, by using different wireless technology for these two networks. For example, a cellular or GSM (Global System for Mobile Communication) wireless technology may be used for access radio network 440, while a WLAN or Wi-MAX (or other) wireless technology may be used for mesh radio network 450. For example, RN 407 may include two wireless transceivers, including a first cellular transceiver for communicating via the access radio network with MNs 403, 404, 405, etc., and a second WLAN or WiMAX transceiver for communicating with other RNs or AGs via mesh radio network 450. In another example embodiment, RN 407 may include a first WLAN transceiver for communicating with MNs via access radio network 440, and a second WiMAX or cellular transceiver for communicating with other RNs and AG via mesh radio network 450. These are merely examples and other technologies may be used. In yet another example embodiment, a same wireless technology may be used in both wireless networks 440 and 450, for example.

For example, by providing mesh radio network 450 that may have wireless media (or channels) orthogonal or separate from (or even using different wireless technology) access radio network 440, a legacy technology may be employed for mobile nodes (MNs) of network 440, while more advanced or newer technology may be used for mesh radio network 450 (e.g., for RNs and AGs). This may also allow protocols, rules, or other aspects of communication or technology for mesh radio network 450 to be independently changed and improved without creating incompatibility issues with existing handsets or mobile nodes (MNs), for example, although this is merely an example embodiment, and the disclosure is not limited thereto.

According to an example embodiment, some RNs, such as RNs 407 and 414 which may be part of both access radio network 440 and mesh radio network 450, may include two separate radio interfaces or wireless interfaces (which may also be referred to as, or which may include, a wireless transceiver). For example, RN 407 may include a first radio interface (or first wireless transceiver) to communicate with MNs on the access radio network 440, and may include a second radio interface (or second wireless transceiver) to communicate with other RNs and AGs via mesh radio network 450. The first radio interface may use different technology or may use resources which are different or even orthogonal to those resources of the second radio interface. For example, the first radio interface of RN 407 may transmit and receive signals via a first set of resources (e.g., first set of carrier frequencies, channels, time slots, hopping sequences or other resources), while the second radio interface of RN 407 may transmit and receive via a second set of resources, which may be different from the first set of resources. According to an example embodiment, having a RN that may include two different radio interfaces (e.g., one radio interface for an access radio network 440 and another radio interface for mesh radio network 450) may allow the RN to receive data via one of the radio interfaces, while, at substantially the same time, may transmit data via the other radio interface. This type of arrangement, although not required, may allow a RN to receive a block of data from another RN or AG (via the mesh radio network 450) via a first radio interface and quickly forward the block of data via a second radio interface to a MN (via the access radio network 440), or vice versa. For example, such a dual radio interface arrangement may allow for a block of data to be received at a RN during a first time slot, and during the same time slot the RN may begin forwarding (or forward) the block of data at the same time the RN continues to receive the remainder of the block of data. This is merely an example embodiment, and a variety of other configurations may be used.

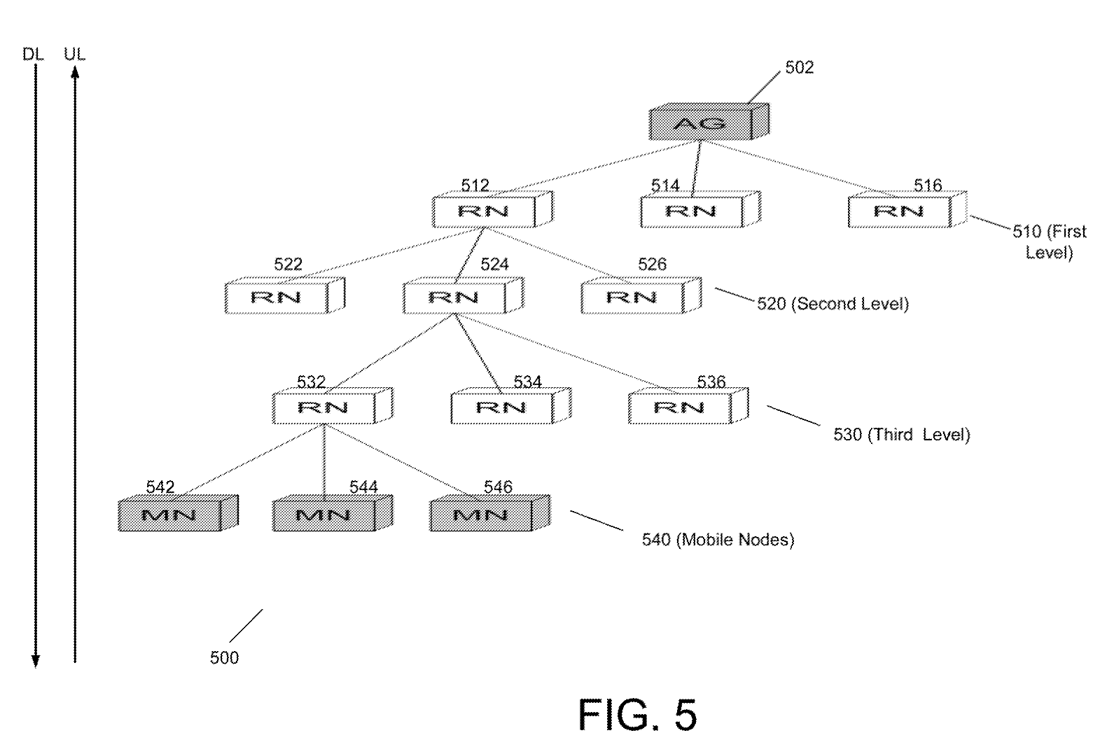

FIG. 5 is a diagram illustrating a tree structure for a wireless network according to an example embodiment. Network 500, which may be a mesh network or relay network for example, may include an access gateway (AG) 502 and one or more levels of relay nodes. A level may, for example, refer to a number of hops that a RN may be from the AG, or a number of hops the RNs are from a MN, for example. Or, for example, RNs may be grouped together based on a number of hops they are from the AG, or a number of hops from a MN, etc. Although this is just an example, and any numbering system or numbering convention may be used to identify levels or groups of RNs.

In this example illustrated in FIG. 5, a first level (of RNs) 510 may include, for example, RNs 512, 514, and 516, and a second level 520 of RNs may include RNs 522, 524 and 526, and a third level 530 of RNs may include RNs 532, 534, and 536, although any number of levels any number of RNs per level may be provided. For example, fourth and fifth levels of RNs may be provided, etc. One or more mobile nodes (MNs) may be provided, such as mobile nodes 542, 544 and 546, which may be serviced by RN 532 in this example. Likewise, although not shown, the other RNs 534 and 536 at the third level 530 may similarly have one or more MNs which they service (e.g., MNs may be directly coupled to a third level RN that is providing service to the MN).

Thus, according to an example embodiment, referring to the example shown in FIG. 5, the MNs may communicate with their directly coupled RNs at the third level 530 via the access radio network 440 (FIG. 4), while RNs and AG 502 may communicate with each other via a mesh radio network 450, for example. Therefore, in an example embodiment, one or more (or even all) of the RNs 532, 534, 536 at the third level 530 (which straddles both networks 440 and 450), as an example, may include a first radio interface (or a first wireless or radio transceiver) for transmitting and receiving data via access radio network 440, and may include a second radio interface (or a second wireless or radio transceiver) for transmitting and receiving data with other RNs and AG 502 via mesh radio network 450.

According to an example embodiment, any modulation scheme may be used. For example, in one example embodiment, the one or more RNs may operate in a time division duplex (TDD) manner, where each RN may transmit during a time slot or phase, e.g., as part of TDD or OFDMA or other modulation scheme. Other modulation or access schemes may be used, such as CDMA (Code Division Multiple Access).

Therefore, according to an example embodiment, a technique may be provided to transmit data using a multi-phase operation. For example, referring to FIG. 5, a first group of RNs (e.g., including first level 510 and third level 530) may transmit, and a second group (e.g., second level 520) may receive, during a first phase (or time slot), while the second group of RNs may transmit and the first group may receive during a second phase or time slot. This is merely an example. In this manner, during each phase, one group of the RNs (or nodes) is transmitting, and the other group is receiving. During another phase or time slots, roles may be reversed, allowing the group that was receiving to now transmit, and the group that was transmitting to now receive. Also, this division of transmission into phases may include separate phases for uplink and downlink transmission, where uplink may generally refer to a transmission towards the AG, while downlink may refer to a transmission away from the AG (e.g., towards a MNs).

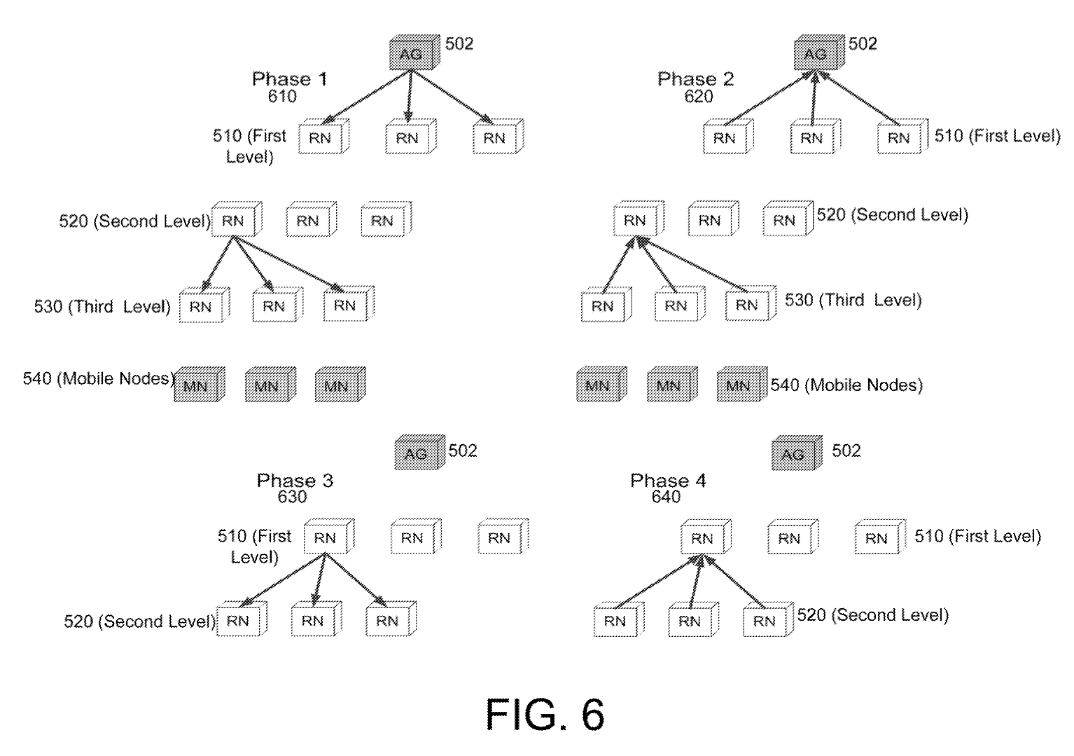

FIG. 6 is a diagram illustrating a 4-phase operation for transmission for a wireless network according to an example embodiment. The phases may include phase 1, phase 2, phase 3 and phase 4, as examples. In this example illustrated in FIG. 6, a first group of wireless nodes may be simplified as first level 510 and third level 530 (but may include other levels), and a second group of wireless nodes may be simplified as a second level 520 (and may include other levels of nodes or RNs, such as a fourth level not shown). Resources (e.g., time slots, channels, subcarrier frequencies, or other resources) may be allocated to the different levels of nodes for the different phases as shown, e.g., in order to more efficiently use the wireless media. The media may be reserved or allocated to nodes or groups of nodes, or resources may be obtained based on a contention-based channel access, for example.

Referring to FIG. 6, at phase 1 610 (which may include a timeslot or group of timeslots), nodes of a first level 510 and third level 530 may receive frames (e.g., data frames, such as unicast, broadcast or multicast, and/or control frames, or other frames) in a downlink direction (from AG and a second level respectively), while nodes of second level 520 may transmit frames (e.g., data frames, control frames, or other frames) in a downlink direction to third level 530.

During phase 2 620 (which may include a timeslot or group of timeslots), a first level 510 and third level 530 of nodes may transmit in the uplink direction (e.g., to AG 502 and second level 520, respectively), while a second level 520 of nodes may receive in the uplink direction (e.g., from a third level 530).

During phase 3 630, the first level 510 (and third level, not shown) of nodes may transmit in the downlink direction, while the second level 520 of nodes may receive in the downlink direction. Also during phase 3 630, although not shown, third level RNs 530 may also transmit in a downlink direction to one or more MNs 540.

During phase 4 640, the first level 510 (and third level not shown) may receive in an uplink direction, and the second level 520 may transmit in an uplink direction. Also during phase 4 640, although not shown, one or more MNs 540 may transmit in an uplink direction to one or more third level RNs 530.

The 4-phase model illustrated in FIG. 6 is merely an example technique that may be used for communication. However, any model or communications technique may be used to allow nodes in a wireless network to communicate with each other.

As shown in FIG. 6, a path between an AG (or AP) and a MN may, in some cases, encompass multiple hops or RNs. In a network with multiple hops, such as in a mesh network or relay network, the relay nodes (RNs) may extend the capacity or area of the network, but the additional hops provided by the RNs may also introduce significant delay or latency in a wireless network. A number of applications may be sensitive to network delay. In some cases, the multiple hops may create sufficient delay or latency that the network is no longer able to provide some of the MNs with a quality of service that may be required for some time sensitive applications, such as voice over wireless, Voice over IP (VoIP) or other delay sensitive applications.

According to an example embodiment, one or more of the RNs in a wireless network may operate in a decode-and-forward (DF) mode of operation and one or more RNs may operate in an amplify-and-forward (AF) mode of operation. Some RNs within a wireless network may switch between AF and DF modes of operation, based on a request or on timing information, etc., for example.

For example, in an amplify-and-forward (AF) mode, a node may simply amplify and forward the data using the same carrier frequency. For example, in AF mode, a node may down convert the received signal or block of data from a carrier frequency to a baseband or other frequency. The signal may then be up-converted to a same or different carrier frequency, and then amplified and forwarded or transmitted. However, in AF mode, the data block is typically not decoded, and as a result, there are significant processing limitations in AF mode. For example, in AF mode, a node is typically unable to reallocate data to a new subcarrier, change the coding or modulation schemes, or make other types of detailed parameter adjustments. The received signal, including any noise, will be amplified before transmission or forwarding, using AF mode. However, because less processing is typically performed in AF mode, as compared to DF mode, AF mode of forwarding may add less delay as compared to DF mode. Also, for example, according to an example embodiment, due to the short delays, a node may be able to begin receiving a block via a first carrier frequency, and may down-convert, and then up-convert the signal to a second carrier frequency (which may be the same or different frequency as the first carrier frequency) and transmit or forward the block of data via the second carrier frequency with a relatively small delay. This may allow, for example, a node to receive a block of data via a first carrier frequency and to quickly forward the block of data via a second carrier frequency.

For example, in a decode-and forward (DF) mode, a node may typically decode the received data, and then re-encode and transmit (or forward) the data. DF mode may allow a node to perform a number of different types of processing on the signals or data. For example, using a DF mode, RNs may schedule or allocate the resources between different data flows (or different users or MNs) in a more efficient manner, as compared to amplify-and-forward (AF) mode.

In an illustrative example, in DF mode, a node may receive a signal including a block of data, may down-convert the signal from a carrier frequency (e.g., to baseband or other frequency), and may decode the block of data. After being decoded, the wireless node may perform a number of different types of processing on the data, such as re-allocating data to different subcarrier frequencies or channels or time slots, adjusting amplitude on different subcarriers, filtering out or removing data on one or more of the subcarriers, or other types of processing. A node operating in DF mode may be able to perform a more detailed processing and may adjust one or more parameters for the block of data, and may allow a more efficient use or a re-allocation of resources, as compared to AF mode. For example, in DF mode, a modulation scheme, coding scheme, amplitude and/or other parameters may be adjusted for each subcarrier.

Also, if a RN operating in DF mode receives a block of data including data addressed to a group of MNs, but the RN only serves one of the MNs, the RN may select for forwarding only the data or the subcarrier addressed to the served MN, while discarding the data directed to non-served MNs, for example. The data may then be re-encoded using a selected coding scheme, modulated using a selected modulation scheme, up-converted to a same or different carrier frequency and transmitted or forwarded to the served MN. This may avoid the duplicative (and thus inefficient) transmission of data for non-served MNs, for example. However, the additional processing power and flexibility offered by DF mode may typically introduce additional processing delays, as compared to AF mode.

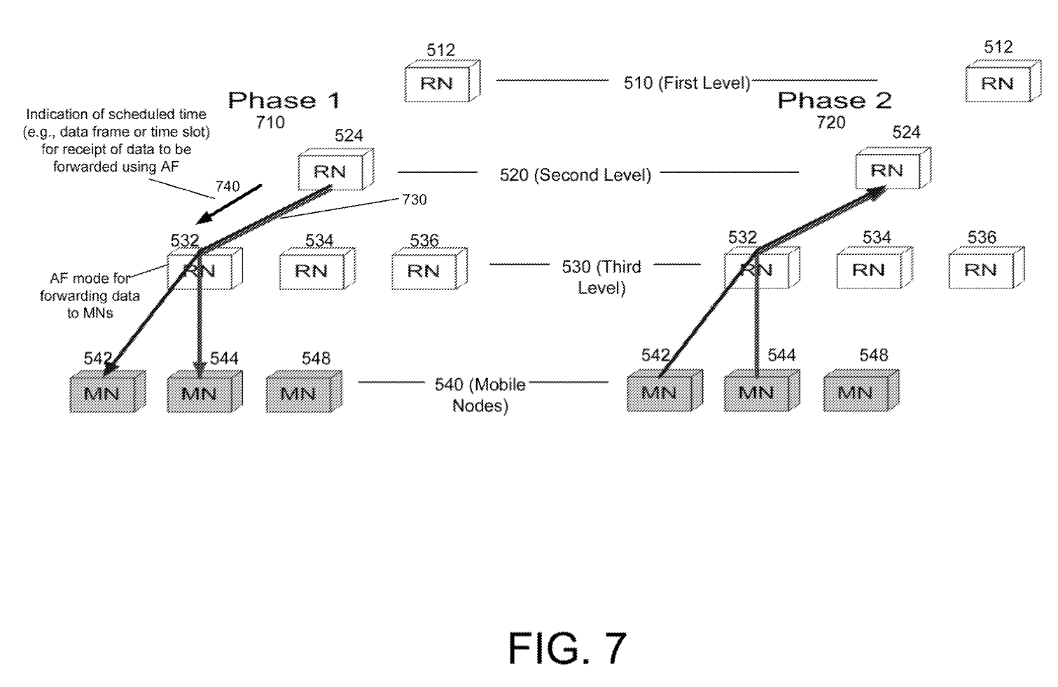

FIG. 7 is a diagram illustrating a wireless network that may include both amplify-and-forward (AF) relay nodes and decode-and-forward (DF) relay nodes. In at least some cases, RNs located near the AG (such as first level RNs 510) may carry traffic from the AG to lower levels in downlink direction. As a result, RNs located close to the AG or AP typically experience a higher density of traffic or greater congestion, as compared to lower level RNs (e.g., third level RNs). Also, MNs associated with (or served by) RNs located near the AG (such as a MN associated with a first level RN) may experience shorter delays than the MNs located farther away from the AG, due to fewer hops between the MN and the AG. On the other hand, a MN associated with a relay node located at a higher level (or further away from the AG) may experience lower traffic density, but may experience much higher delays as compared to MNs closer to the AG, due to the additional hops between AG and MN. Also, MNs (e.g., MNs 542, 544) associated with (or served by) RNs that are located at a boundary between networks, e.g., third level RNs at the boundary between the access radio network 440 and the mesh radio network 450, tend to experience even greater delays than those MNs located nearby the AG due to additional processing that may be performed between network boundaries, for example.

Thus, for example, those MNs at the higher levels or more hops away from the AG, or beyond a network boundary, may experience higher delays than MNs located near the AG. MNs at the higher levels or more hops away from the AG, or at or beyond a network boundary, may typically experience two types of delays: 1) delays from the multiple hops of the wireless network; and 2) delay at the boundary between two networks, such as a delay between mesh radio network 450 and access radio network 440, as an example.

Therefore, according to an example embodiment, the network may be configured to provide one or more RNs located near the AG to operate in a DF mode and one or more RNs at higher levels or farther away from the AG to operate in AF mode.

For example, one or more RNs located near the AG may operate in a DF mode to allow these lower level RNs (e.g., first level 510 RNs) to more efficiently allocate resources and improve throughput. Although DF mode may provide higher delays (as compared to AF mode), the MNs associated with these RNs near the AG may typically experience relatively low delays due to a lower number of hops between AG and MN.

Also the network may be configured to provide one or more RNs, e.g., at higher levels or farther away from the AG or at the network boundary, that may use AF mode to forward data to their associated or served MNs. Thus, at these higher level RNs (e.g., third level RNs 530 in FIGS. 6-7), there may be less need to reallocate resources or more efficiently use resources as traffic density may be lower than RNs coupled directly to the AG (such as first level RNs 510). However, delay at these higher level RNs may be a bigger problem, so it may be advantageous to have one or more of these higher level RNs operate in AF mode, at least for some data blocks or some periods of time.

In another example embodiment, delays across the wireless network may be reduced by allowing some RNs to operate in AF mode, whereas some other RNs may operate in DF mode. For example, the delay across the boundary between two networks may be decreased by combining the last hop transmission in the mesh radio network with the transmission between the final RN and MN by using an AF mode RN at the boundary between these two networks. In other words, by operating the last RN in AF mode, the delay of this last RN may be sufficiently decreased that the last two hops may appear as a single hop, for example. For example, the third level 530 RNs may be at the boundary between mesh radio network 450 and access radio network 440. This delay may be decreased by configuring the last RN (which may be located on the network boundary) to operate in AF mode. For example, the last RN (RN 532) may operate in AF mode, and may receive a block of data via a first radio interface during a first time slot, and may substantially forward the block of data to the MN via a second radio interface during approximately the same time slot, according to an example embodiment.

FIG. 7 illustrates two phases, including phase 1 710 where data is forwarded downlink from RN to MN using AF mode, and phase 2 720 where data is forwarded uplink from MN to RN using AF mode. As shown in FIG. 7, for phase 1 710, RN 524 may be operating, for example, in a DF mode to receive and forward data to third level RN 532. RN 532 may be operating in AF mode, and may receive and forward data to serviced MNs (542, 544) using AF mode, as shown by line 730. Similarly, for phase 2 720, RN 532 may be operating in an AF mode. Data may be received at RN 532 from MNs 542 and/or 544 and immediately forwarded (e.g., during a same time slot) using AF mode to RN 524, for example.

According to another example embodiment the forwarding of data shown in FIG. 7 may be performed as follows. The third level RN (RN 532) may be operating in AF mode, and therefore, does not (in this example) decode the received data. RN 532 will then forward all the data it receives while in AF mode. If the received signal contains data for MNs not served by RN 532 (such as MN 548), receiving and transmitting this data (including data for unserved MN 548) may not be an efficient use of resources and may typically increase the interference in the access radio network 440 (coupling third level RNs 530 to MNs 542, 544, 546).

To avoid this problem, according to an example embodiment, RN 532 may receive and forward data that is directed to or scheduled for MNs served by RN 532 while RN 532 is operating in AF mode. Referring to FIG. 7, in an example embodiment, RN 524 may provide to RN 532 an indication 740 of a scheduled time when RN 532 should receive data (e.g., from RN 524) that should be forwarded using AF mode. For example, the second level RN (RN 524 may send a request to RN 532 for RN 532 to forward data via AF mode, or third level RN 532 may send the request to RN 524 to initiate the AF mode data transfer. The indication may identify the scheduled time for AF mode transfer, e.g., as a time slot, frame number, or other indication. According to an example embodiment, at or prior to the scheduled time, the RN 532 may switch from DF mode to AF mode (if not already in AF mode), and may then receive and forward the data in AF mode to one or more MNs being serviced by RN 532. For example, after forwarding the data via AF mode, the RN 532 may then switch back to DF mode, at least in some cases.

The third level RN (e.g., RN 532) may initiate the AF data forwarding by, for example, sending a request to the second level RN (e.g., RN 524) indicating that the third level RN would like to transmit to the MNs it serves using AF mode. The third level RN may also provide wireless link quality measurements to the second level RN for each served MN, so that the second level RN may perform link adaptation, e.g., to select a coding scheme and modulation scheme appropriate for each MN. The second level RN (RN 524) may then send an indication 740 of a scheduled time (e.g., time slot or frame number) that the third level RN (RN 532) will receive data to be forwarded to serviced MNs using AF mode. During receipt these indicated data frames or time slots, the third level RN (e.g., RN 532) may switch to AF mode so that this data may be received and immediately forwarded to serviced MNs, e.g., during a same time slot, and either on a same or different carrier. The RN operating in AF mode may forward the data during a same time slot for example, on a different carrier frequency than the data was received. Alternatively, a same carrier frequency may be used to forward the data, e.g., by forwarding the data during the next time slot to the serviced (or associated) MNs.

Thus, data forwarding in AF mode may be performed in a full duplex operation, e.g., where data may be received and transmitted (forwarded) at approximately the same time (such as on same or different carrier frequencies), or in a half duplex manner. For half duplex relay, the RN may receive during a first time slot, and forward during a second time slot. In either case (full or half), AF mode may decrease delays since the RN may avoid the delays of processing associated with DF mode, such as e.g., decoding, segmentation and reassembly, and re-encoding.

The uplink data forwarding in AF mode, shown in phase 2 720, may be performed in a similar manner. RN 532 may be operating in AF mode, or may switch from DF mode to AF mode prior to a transmission from one or more MNs 542, 544, etc. The data may be received and forwarded using AF mode. Thus, in the uplink direction, delays may be decreased by having one or more RNs, such as higher level RNs or RNs at the network boundary, operate in an AF mode, at least for some data transmissions. As with downlink operation, the RN (e.g., RN 532) may operate in AF full time, or may typically operate in DF mode, and then may switch to AF mode upon request or at scheduled times or as needed, etc.

In addition, AF relaying may be performed for some data flows when a routing and/or resource reservation between end nodes has been established beforehand, e.g., where the nodes agree to reserve resources, or agree to forward certain data flows or certain packets, etc. using AF mode.

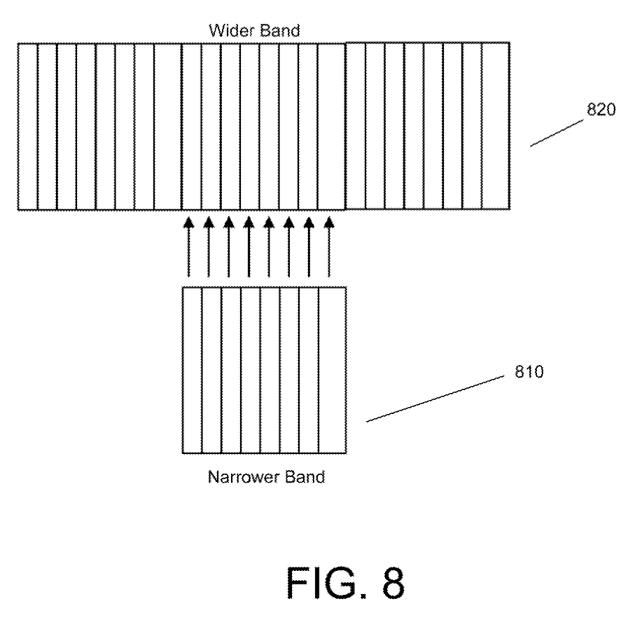

FIG. 8 is a diagram illustrating forwarding of data by a node having two radio interfaces that have different bandwidths according to an example embodiment. RN 532 (for example) may be operating in AF mode to forward data received from RN 524 to one or more serviced MNs. RN 532 may include a first radio interface associated with mesh radio network 450 for receiving the data from RN 524, and a second radio interface associated with access radio network 440 for forwarding the data to serviced MNs. In this example, the bandwidth 810 of mesh radio network 450 may be less than the wider bandwidth 820 of the access radio network (or vice versa). Therefore, the received transmissions received via the first network may fit into the bandwidth of the second network, for example. In this example, other than different bandwidths, the two radio networks may have otherwise substantially similar radio parameters, such as an OFDM transmission with same or similar subcarrier spacing, cyclic prefix, and subcarrier bandwidth, but maybe with different number of subcarriers in one OFDM symbol. Where mapping from narrower bandwidth 810 to wider bandwidth 820, zero power may be applied to those unused carriers in the wider bandwidth 820. A mapping from a wider bandwidth to narrower bandwidth may also be performed, e.g., there the transmitter formats the signal so that all the data is concentrated or provided only on the narrower band.

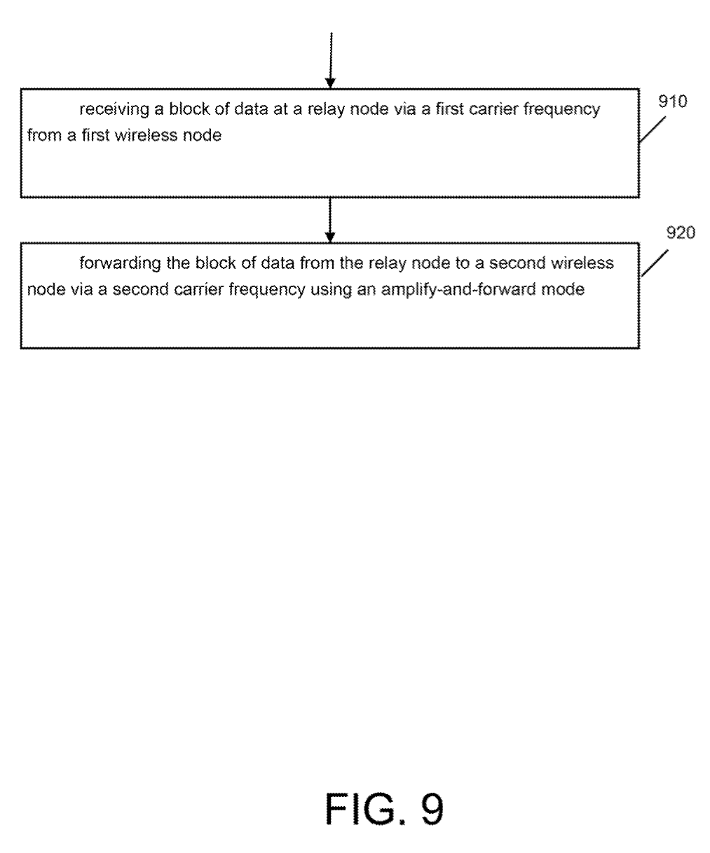

FIG. 9 is a flow chart illustrating operation of a wireless node (e.g., relay node) according to an example embodiment. At 910, a block of data may be received at a relay node via a first carrier frequency from a first wireless node. At 920, the block of data may be forwarded from the relay node to a second wireless node via a second carrier frequency using an amplify-and-forward (AF) mode.

Operation 910 (receiving) may include, for example, receiving a block of data at a relay node via a first carrier frequency from a first wireless node that is operating in a decode-and-forward (DF) mode. For example, the block of data received from the first wireless node may include only data directed to one or more mobile nodes being serviced by the relay node.

Operation 920 (forwarding) may include down converting the block of data from a first carrier frequency, without decoding the block of data, up-converting the block of data to a second carrier frequency, and forwarding the block of data via the second carrier frequency. In an example embodiment, the forwarding (920) may include forwarding, substantially immediately after the receiving has begun, at least a portion of the block of data via the second carrier frequency.

In an example embodiment, the receiving (910) may include receiving a block of data at a first radio interface of a relay node via a first carrier frequency, and the forwarding (920) may include forwarding the block of data from a second radio interface of the relay node via a second carrier frequency using an amplify-and-forward (AF) mode (without decoding the received block of data).

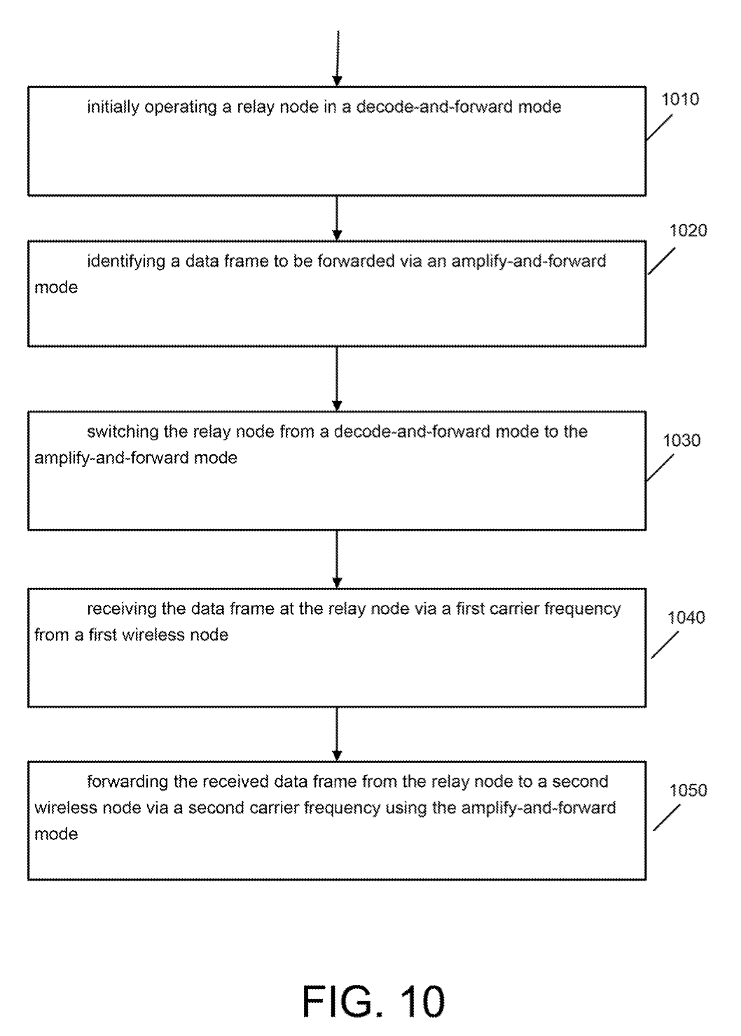

FIG. 10 is a flow chart illustrating operation of a wireless node (e.g., relay node) according to another example embodiment. At 1010, a relay node may be initially operating in a decode-and-forward (DF) mode. At 1020, a data frame may be identified to be forwarded via an amplify-and-forward (AF) mode. At 1030, the relay node may switch from a DF mode to an AF mode. At 1040, the data frame may be received at the relay node via a first carrier frequency from a first wireless node. At 1050, the received data frame may be forwarded from the relay node to a second wireless node (e.g., another relay node or a mobile node) via a second carrier frequency using the AF mode.

Operation 1020 (identifying a data frame to be forwarded . . . ) may include receiving an indication when (e.g., frame, time or time slot) one or more data frames for which the relay node should use an AF mode to forward the data frames to one or more wireless nodes (e.g., MNs) being serviced by the relay node.

Operation 1040 (receiving the data frame) may include, for example, receiving the data frame at the relay node from a first wireless node that is operating in a DF mode, wherein the data frame received from the first wireless node includes only data directed to one or more MNs being serviced by the relay node.

According to another example embodiment, a wireless network may be provided that may include a plurality of wireless nodes. The wireless network may include a first relay node coupled, either directly or indirectly, to an access gateway, the first relay node operating in a DF mode. And, a second relay node coupled, either directly or indirectly, to the first relay node and to one or more mobile nodes being serviced by the second relay node, the second relay node operating, at least for a forwarding of some data blocks, in an AF mode. For example, the first relay node (e.g., RN 524) may use a first radio interface (e.g., radio interface for mesh radio network 450) to receive and forward data, and the second relay node (e.g., RN 532) uses a first radio interface (e.g., radio interface for mesh radio network 450) to receive data and a second radio interface (e.g., radio interface for access radio network 440) to forward or transmit data to the one or more mobile nodes.

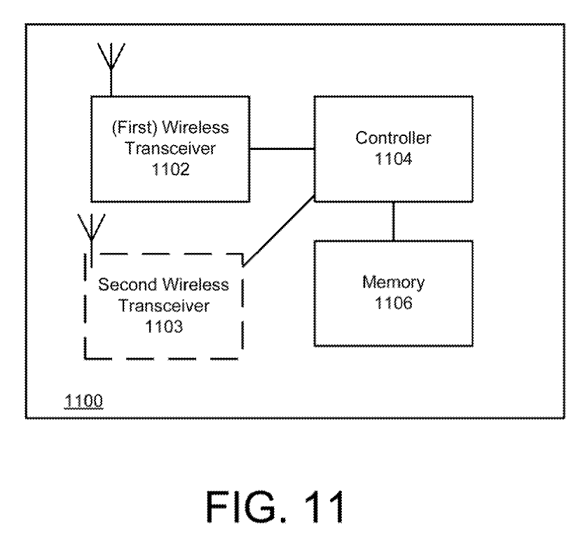

FIG. 11 is a block diagram illustrating an apparatus 1100 that may be provided in a wireless node according to an example embodiment. The wireless node (e.g. station or AP) may include, for example, a wireless transceiver(or radio interface) 1102 to transmit and receive signals, a controller 1104 to control operation of the station and execute instructions or software, and a memory 1106 to store data and/or instructions.

Controller 1104 may be programmable and capable of executing software or other instructions stored in memory or on other computer media to perform the various tasks and functions described above, such as one or more the tasks or methods described above.

In another example embodiment, apparatus 1100 may include two wireless transceivers (or radio interfaces). For example, apparatus 1100, which may be provided at a RN (for example), may include a first wireless transceiver 1102 for communicating with MNs via access radio network 440 (e.g., WLAN or cellular transceiver), and a second wireless transceiver (e.g., WiMAX or cellular transceiver) for communicating with other RNs and AG via mesh radio network 450. These are merely examples and other technologies may be used.

In addition, a storage medium may be provided that includes stored instructions, when executed by a controller or processor that may result in the controller 1104, or other controller or processor, performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While certain features of the described implementations have been illustrated as described herein, many modifications, substitutions, changes and equivalents will now occur to those skilled in the art

1. A method of forwarding data in a wireless network comprising:
receiving a block of data at a relay node via a first carrier frequency from a first wireless node; and
forwarding the block of data from the relay node to a second wireless node via a second carrier frequency using an amplify-and-forward mode.

2. The method of claim 1 wherein the receiving comprises receiving a block of data at a relay node via a first carrier frequency from a first wireless node that is operating in a decode-and-forward mode.

3. The method of claim 1 wherein the receiving comprises receiving a block of data at a relay node via a first carrier frequency from a first wireless node that is operating in a decode-and-forward mode, the first block of data received from the first wireless node including only data directed to one or more mobile nodes being serviced by the relay node.

4. The method of claim 1:
wherein the receiving comprises receiving a block of data at a relay node during a first timeslot via a first carrier frequency from a first wireless node;
wherein the forwarding comprises forwarding the block of data from the relay node to a second wireless node substantially during a portion of the first timeslot via a second carrier frequency using an amplify-and-forward mode; and
wherein at least a portion of the block of data being forwarded via a second carrier frequency at substantially the same time that a portion of the block of data is being received via the first carrier frequency.

5. The method of claim 1 wherein the receiving comprises:
initially operating the relay node in a decode-and-forward mode;
receiving an indication of a data frame to be forwarded via an amplify-and-forward mode;
switching the relay node from a decode-and-forward mode to the amplify-and-forward mode; and
receiving the data frame at the relay node via the first carrier frequency from the first wireless node; and
wherein the forwarding comprises forwarding the received data frame from the relay node to a second wireless node via a second carrier frequency using an amplify-and-forward mode.

6. The method of claim 1 wherein the forwarding comprises:
down-converting the block of data from the first carrier frequency, without decoding the block of data;
up-converting the block of data to a second carrier frequency; and
forwarding the block of data via the second carrier frequency.

7. The method of claim 1 wherein the forwarding comprises:
forwarding, substantially immediately after the receiving has begun, at least a portion of the block of data via the second carrier frequency.

8. The method of claim 1:
wherein the receiving comprises receiving a block of data at a first radio interface of a relay node via a first carrier frequency; and
wherein the forwarding comprises forwarding the block of data from a second radio interface of the relay node via a second carrier frequency using an amplify-and-forward mode without decoding the received block of data.

9. An apparatus for wireless communications, the apparatus comprising:
a controller;
a memory coupled to the controller; and
a wireless transceiver coupled to the controller;
the apparatus configured to:
select a forwarding mode of operation from a plurality of forwarding modes, the plurality of forwarding modes including an amplify-and-forward mode and a decode-and-forward mode;
receive a block of data from a first wireless node; and
forward the block of data to a second wireless node using the selected forwarding mode.

10. The apparatus of claim 9 wherein the apparatus being configured to receive comprises the apparatus being configured to:
initially operate the apparatus in a decode-and-forward mode;
receive an indication of a scheduled time when the apparatus will receive data to be forwarded using an amplify-and-forward mode;
switch the apparatus from a decode-and-forward mode to the amplify-and-forward mode at or before the scheduled time; and
receiving the block of data via the first carrier frequency from the first wireless node during the scheduled time.

11. The apparatus of claim 9:
wherein the apparatus being configured to receive comprises the apparatus being configured to:
initially operate the relay node in a decode-and-forward mode;
receive an indication of a data frame to be forwarded via an amplify-and-forward mode;
switch the relay node from a decode-and-forward mode to the amplify-and-forward mode, the amplify-and forward mode being the selected forwarding mode; and
receive the data frame at the relay node via the first carrier frequency from the first wireless node; and
wherein the apparatus being configured to forward comprises the apparatus being configured to forward the received data frame from the relay node to a second wireless node via a second carrier frequency using the amplify-and-forward mode.

12. A method comprising:
initially operating a relay node in a decode-and-forward mode;
identifying a data frame to be forwarded via an amplify-and-forward mode;
switching the relay node from a decode-and-forward mode to the amplify-and-forward mode; and
receiving the data frame at the relay node via a first carrier frequency from a first wireless node; and
forwarding the received data frame from the relay node to a second wireless node via a second carrier frequency using the amplify-and-forward mode.

13. The method of claim 12 wherein the receiving the data frame comprises receiving the data frame at the relay node from a first wireless node that is operating in a decode-and-forward mode, wherein the data frame received from the first wireless node includes only data directed to one or more mobile nodes being serviced by the relay node.

14. The method of claim 12 wherein the identifying a data frame comprises receiving a request from the first wireless node identifying one or more data frames for which the relay node should use an amplify-and-forward mode to forward the data frames to one or more wireless nodes being serviced by the relay node.

15. The method of claim 12 wherein the identifying a data frame comprises receiving an indication when one or more data frames will be received for which the relay node should use an amplify-and-forward mode to forward the data frames to one or more wireless nodes being serviced by the relay node.

16. A computer program, the computer program product being tangibly embodied on a computer-readable medium and including executable code that, when executed, is configured to cause one or more processors to:
receive an indication of a scheduled time when a relay node will receive a block of data to be forwarded via an amplify-and-forward mode;
switch the relay node from a decode-and-forward mode to the amplify-and-forward mode at or before the scheduled time;
receive the block of data at the relay node from a first wireless node at approximately the scheduled time; and
forward the block of data from the relay node to a second wireless node using an amplify-and-forward mode.

17. A system comprising:
a first relay node in a wireless network coupled, either directly or indirectly, to an access gateway, the first relay node operating in a decode-and-forward mode; and
a second relay node in the wireless network coupled, either directly or indirectly, to the first relay node and to one or more mobile nodes being serviced by the second relay node, the second relay node operating, at least for a forwarding of some data blocks, in an amplify-and-forward mode.

18. The system of claim 17 wherein the first relay node uses a first radio interface to receive and forward data, and the second relay node uses a first radio interface to receive data and a second radio interface to forward or transmit data to the one or more mobile nodes.

19. The system of claim 17 wherein the first relay node uses a first radio interface to communicate over a first wireless network, and the second relay node uses a first radio interface to communicate over the first wireless network with the first relay node and a second radio interface to communicate with one or more mobile nodes over a second wireless network.
